(19) United States
(12) Patent Application Publication
(10) Pub. No.: US 2012/0017717 A1
(43) Pub. Date: Jan. 26, 2012

(54) GEAR TRANSMISSION DEVICE AND ROBOT ARM USING THE SAME

(75) Inventor: BO LONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 12/975,700

(22) Filed: Dec. 22, 2010

(30) Foreign Application Priority Data
Jul. 20, 2010 (CN) 201010231643.9

(51) Int. Cl. B25J 18/00; F16H 57/12

(52) U.S. Cl. 74/490.01; 74/392

(57) ABSTRACT

A gear transmission device includes a first input shaft, a first transmission gear, a first output shaft, and a first gear clearance adjustment mechanism. The first transmission gear sleeves on the first input shaft. The first gear clearance adjustment mechanism includes two adjustment gears. The two adjustment gears separately sleeve on the first output shaft and both mesh with the first transmission gear, such that the first input shaft is rotatably assembled with the first output shaft. Two sides of gear teeth of the first transmission gear resist gear teeth of the two adjustment gears respectively, such that the first transmission gear and the two adjustment gears are prevented from damage by interference. Therefore, a collision force and a noise between the first transmission gear and the two adjustment gears are decreased. The invention also provides a robot arm using the gear transmission device.

### BACKGROUND

1. Technical Field

The present disclosure relates to gear transmission, and particularly, to a gear transmission device and robot arm using the same.

2. Description of Related Art

Gear transmission devices are widely applied to many fields to smoothly and silently transmit rotation. A commonly used gear transmission device usually includes at least one set of gear pairs. Each gear pair includes two gears meshing and respectively assembled to an input shaft and an output shaft. When assembling the gear transmission device, the two gears of the gear transmission device mesh and cooperatively form a gear clearance therebetween, to ensure smooth transmit of the gear transmission and prevent seizing during usage. However, the gear clearance of the commonly used gear transmission device is not adjustable, and collision force and noise may be generated after time.

Therefore, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the gear transmission device and robot arm using the same. Moreover, in the drawings like reference numerals designate corresponding parts throughout the several views. Wherever possible, the same reference numerals are used throughout the drawings to refer to the same or like elements of an embodiment.

FIG. 1 is a cross section of an embodiment of a robot arm including a housing and a gear transmission device assembled within the housing, the gear transmission device including a clearance adjustment mechanism.

FIG. 2 is a schematic plane view of a first transmission gear meshing with a first adjustment gear of the clearance adjustment mechanism shown in FIG. 1.

FIG. 3 is a schematic plane view of the first transmission gear meshing with a second adjustment gear of the clearance adjustment mechanism shown in FIG. 1.

### DETAILED DESCRIPTION

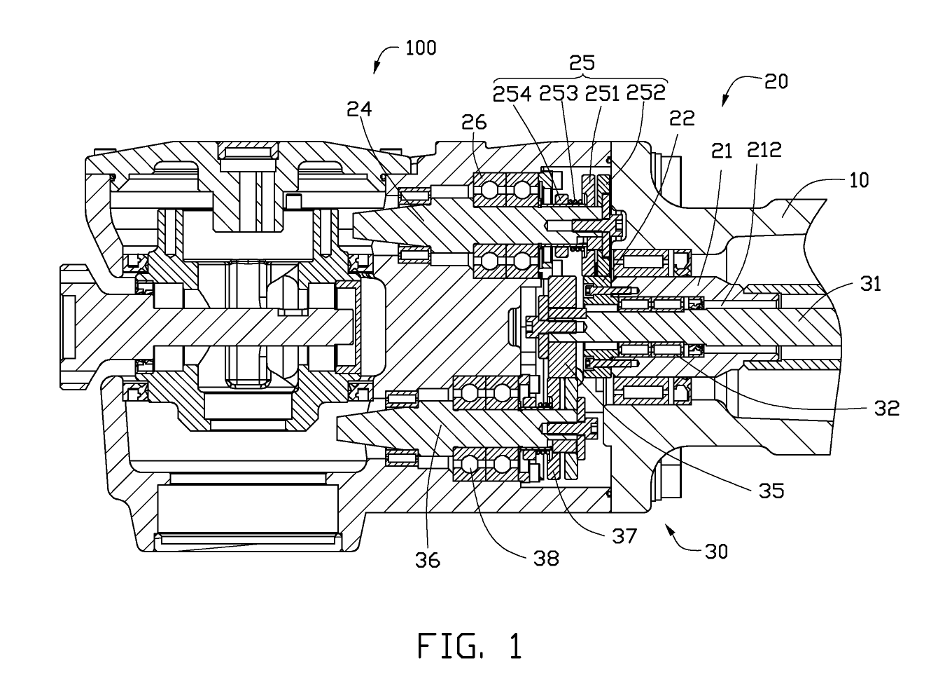

Referring to FIG. 1, an embodiment of a robot arm 100 includes a housing 10, and a gear transmission device (not labeled) assembled within the housing 10. The gear transmission device includes a first transmission assembly 20 and a second transmission assembly 30. In the illustrated embodiment, the first transmission assembly 20 is assembled with a fifth shaft of a six-shaft robot (not shown), and the second transmission assembly 30 is assembled with a sixth shaft of the six-shaft robot (not shown).

The first transmission assembly 20 includes a first input shaft 21, a first transmission gear 22, a first output shaft 24, a first gear clearance adjustment mechanism 25, and two first bearings 26. The first transmission gear 22 sleeves on one end of the first input shaft 21. The first gear clearance adjustment mechanism 25 sleeves on one end of the first output shaft 24 and rotatably meshes with the first transmission gear 22. The two first bearings 26 sleeve on a middle portion of the first output shaft 24 and are both assembled to the housing 10 such that the first output shaft 24 is rotatably assembled within the housing 10 via the two first bearings 26. In the illustrated embodiment, the first output shaft 21 defines an axial accommodating hole 212. The first transmission gear 22 is a broad helical gear.

The first gear clearance adjustment mechanism 25 includes a first adjustment gear 251, a second adjustment gear 252, an elastic member 253, and a fixing member 254. The first adjustment gear 251 and the second adjustment gear 252 are separately assembled to one end of the first output shaft 24. The first adjustment gear 251 and the second adjustment gear 252 cooperatively form a clearance (not labeled) therebetween. The first and second adjustment gears 251, 252 both mesh with the first transmission gear 22. The fixing member 254 is fixed to the first output shaft 24 adjacent to the first adjustment gear 251. The elastic member 253 is elastically sandwiched between the fixing member 254 and first adjustment gear 251, and with two ends thereof respectively resisting the fixing member 254 and the first adjustment gear 251. In the illustrated embodiment, the first adjustment gear 251 and the second adjustment gear 252 are both thin helical gears. The fixing member 254 is an adjusting nut sleeving on the first output shaft 24. The elastic member 253 is a coil spring sleeving on the output shaft 24 and elastically sandwiched between the fixing member 254 and the first adjustment gear 251.

The second transmission assembly 30 includes a second input shaft 31, two second bearings 32, a second transmission gear 35, a second output shaft 36, a second gear clearance adjustment mechanism 37, and two third bearings 38. The second input shaft 31 is partially received within the axial accommodating hole 212 of the first input shaft 21. The two second bearings 32 sleeve on the second input shaft 31 and are both rotatably assembled within the axial accommodating hole 212 of the first input shaft 21 together with the second input shaft 31, such that the second input shaft 31 is rotatably assembled within the axial accommodating hole 212 via the two second bearings 32. The second transmission gear 35 fixedly sleeves on one end of the second input shaft 31. The second gear clearance adjustment mechanism 37 fixedly sleeves on one end of the second output shaft 36. The two third bearings 38 sleeve on a middle portion of the second output shaft 36 and both assembled with the housing 10, such that the second output shaft 36 is rotatably assembled within the housing 10 via the two third bearings 38. In the illustrated embodiment, the second gear clearance adjustment mechanism 37 has substantially the same shape and structure as that of the first gear clearance adjustment mechanism 25.

Referring to FIG. 1, when the robot arm 100 is in operation, the first input shaft 21 of the first transmission assembly 20 is rotated by the fifth shaft of the six-shaft robot (not shown), and the first transmission gear 22 mounted at one end of the first input shaft 21 is rotated together with the first input shaft 21. The first and second adjustment gears 251, 252 are also driven to rotatably mesh with the first transmission gear 22 synchronously, such that the first output shaft 24 is rotated together with the first and second adjustment gears 251, 252. As the second input shaft 31 of the second transmission assembly 30 is rotated by the sixth shaft of the six-shaft robot (not shown), the second transmission gear 35 mounted at one end of the second input shaft 31 is rotated together with the second input shaft 31. The second gear clearance adjustment mechanism 37 meshing with the second transmission gear 35 is rotated relative to the second transmission gear 35 and the second input shaft 31, whereby the second output shaft 36 is then rotated together with the second gear clearance adjustment mechanism 37.

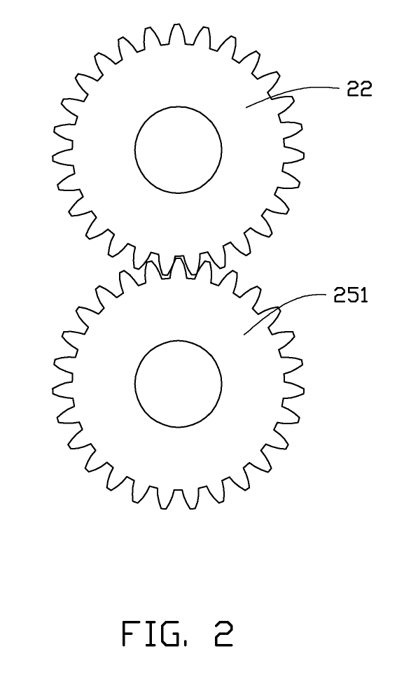

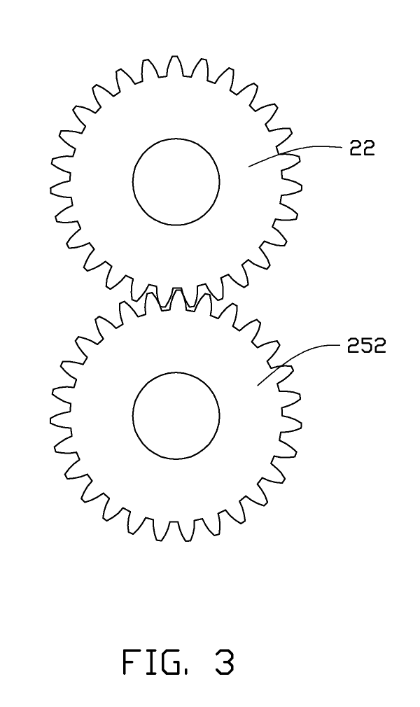

Also referring to FIGS. 2 and 3, as the first adjustment gear 251 of the first gear clearance adjustment mechanism 25 meshes with the first transmission gear 22, the gear clearance is formed at one side of the gear teeth of the first transmission gear 22, and, as the second adjustment gear 252 meshes with the first transmission gear 22, the gear clearance is formed at the other side of the gear teeth of the first transmission gear 22. Thus, two sides of the gear teeth of the first transmission gear 22 respectively resist the first and second adjustment gears 251, 252, such that the gear teeth of the first transmission gear 22 are kept from sliding and collision force and noise between the first transmission gear 22 and the first and second adjustment gears 251, 252 are minimized during use. Resistance of the elastic member 253 against the first adjustment gear 251 can automatically adjust the gear clearance between the first and second adjustment gears 251, 252.

It is understood that the elastic member 253 and the fixing member 254 may selectively be omitted. If the fixing member 254 is omitted, the elastic member 253 directly resists the housing 10. The elastic member 253 is not limited to a spring, nor is the fixing member 254 limited to an adjusting nut, but can also be, for example, a snap spring latching with the first output shaft 24.

It is to be understood, however, that even through numerous characteristics and advantages of the disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A gear transmission device, comprising:
a first input shaft;
a first transmission gear sleeved on the first input shaft;
a first output shaft; and
a first gear clearance adjustment mechanism comprising two adjustment gears separately sleeved on the first output shaft and both meshing with the first transmission gear, such that the first input shaft is rotatably assembled with the first output shaft.

2. The gear transmission device of claim 1, wherein each of the first transmission gear and the two adjustment gears comprise gear teeth, two sides of the gear teeth of the first transmission gear respectively resists the gear teeth of the two adjustment gears.

3. The gear transmission device of claim 1, wherein the first gear clearance adjustment mechanism further comprises an elastic member having two ends respectively resisting against the first output shaft and one adjustment gear.

4. The gear transmission device of claim 3, wherein the elastic member is a coil spring sleeving on the first output shaft.

5. The gear transmission device of claim 4, wherein the first gear clearance adjustment mechanism further comprises a fixing member fixed to the output shaft and positioned adjacent to the two adjustment gears, two ends of the elastic member respectively resist the fixing member and one adjustment gear.

6. The gear transmission device of claim 5, wherein the fixing member is an adjusting nut or a snap spring.

7. The gear transmission device of claim 1, wherein the first transmission gear is a broad helical gear.

8. The gear transmission device of claim 7, wherein the first output shaft defines an axial accommodating hole, the gear transmission device further comprises a second input shaft, a second transmission gear, a second output shaft, and a second gear clearance adjustment mechanism, the second input shaft is assembled within the axial accommodating hole of the first output shaft, the second transmission gear is fixed to one end of the second input shaft, and the second gear clearance adjustment mechanism is fixed to the second output shaft and rotatably meshes with the second transmission gear.

9. The gear transmission device of claim 8, wherein the gear transmission device further comprises two bearings sleeved on the second input shaft and assembled with first input shaft, such that the second input shaft is rotatably assembled within the first input shaft.

10. The gear transmission device of claim 9, the second gear clearance adjustment mechanism has substantially the same shape and structure as that of the first gear clearance adjustment mechanism.

11. A robot arm, comprising:
a housing; and
a gear transmission device assembled within the housing, the gear transmission device comprising:
a first input shaft;
a first transmission gear sleeved on the first input shaft;
a first output shaft;
a bearing sleeved on the first output shaft and assembled to the housing, such that the first output shaft is rotatably assembled within the housing via the two first bearings;
a first gear clearance adjustment mechanism comprising two adjustment gears separately sleeved on the first output shaft and both meshing with the first transmission gear, such that the first input shaft is rotatably assembled with the first output shaft; and
an elastic member having two ends respectively resisting against the first output shaft and one adjustment gear.

12. The robot arm of claim 11, wherein the first output shaft defines an axial accommodating hole, the gear transmission device further comprises a second input shaft, a second transmission gear, a second output shaft, and a second gear clearance adjustment mechanism, the second input shaft is assembled within the axial accommodating hole of the first output shaft, the second transmission gear is fixed to one end of the second input shaft, and the second gear clearance adjustment mechanism is fixed to the second output shaft and rotatably meshes with the second transmission gear.

13. The robot arm of claim 12, wherein the gear transmission device further comprises two bearings sleeved on the second input shaft and assembled with the first input shaft such that the second input shaft is rotatably assembled within the first input shaft.

14. The robot arm of claim 13, wherein the second gear clearance adjustment mechanism has substantially the same shape and structure as that of the first gear clearance adjustment mechanism.

15. A robot arm, comprising:
a housing;
a first transmission assembly comprising:
a first input shaft;
a first transmission gear sleeved on the first input shaft;
a first output shaft rotatably assembled within the housing;
a first gear clearance adjustment mechanism comprising two adjustment gears separately sleeved on the first output shaft and both meshing with the first transmission gear, such that the first input shaft is rotatably assembled with the first output shaft; and
an elastic member having two ends respectively resisting against the first output shaft and one adjustment gear; and
a second transmission assembly within the housing comprising:
a second input shaft rotatably assembled within the first input shaft;
a second transmission gear fixed to the second input shaft;
an output shaft; and
a second gear clearance adjustment mechanism fixed to the output shaft and meshing with the second transmission gear.

16. The robot arm of claim 15, wherein the robot arm further comprises a bearing, the first output shaft defines an axial accommodating hole, and the second input shaft is rotatably assembled within the axial accommodating hole of the first output shaft via the bearing.

17. The robot arm of claim 16, wherein the second gear clearance adjustment mechanism has substantially the same shape and structure as that of the first gear clearance adjustment mechanism.

18. The robot arm of claim 17, wherein the first gear clearance adjustment mechanism further comprises a fixing member fixed to the output shaft and positioned adjacent to the two adjustment gears.
